(19) United States
(12) Patent Application Publication
(10) Pub. No.: US 2014/0221100 A1
(43) Pub. Date: Aug. 7, 2014

(54) GAME MACHINE SYSTEM AND METHOD FOR PLAYING GAME

(71) Applicant: PROLEXIN PROPERTIES LIMITED, Greenford (GB)

(72) Inventor: Tijs Mul, Barcelona (ES)

(73) Assignee: PROLEXIN PROPERTIES LIMITED, Greenford (GB)

(21) Appl. No.: 14/134,013

(22) Filed: Dec. 19, 2013

Related U.S. Application Data
(60) Provisional application No. 61/739,192, filed on Dec. 19, 2012.

(51) Int. Cl. G07F 17/32

(52) U.S. Cl. CPC G07F 17/3293
USPC 463/42

(57) ABSTRACT

A game machine system for a game to be played by n players in which each player is assigned to a position of a different preferability, n being an integer of at least 2, wherein the system has a processor configured to:
A) assign a player to a first group of n players grouped together to play a first game,
B) when the player leaves the first game, determine whether the player left the first game by winning or by losing and
C) assign the player to a winner queue if the player left the first game by winning and to a loser queue if the player left the first game by losing,
D) start a second game when the total number of players in the winner queue and the loser queue reaches n, by
D1) assigning one player from the winner queue to the most preferred position and (n−1) players from the loser queue to the remaining positions when the winner queue comprises at least one player and
D2) assigning n players from the loser queue to the most preferred position and the remaining positions when the winner queue has no player.

### FIELD OF THE INVENTION

The invention relates to a game machine system for playing a game such as poker. The invention further relates to a method for playing a game such as poker.

### BACKGROUND OF THE INVENTION

Poker is a card game that many people enjoy playing. Each player takes a turn in dealing the cards and each player receives a designated number of cards, The hand is evaluated in accordance with game rules in which some combinations are ranked higher than others.

Poker can be played in a variety of situations. Traditionally, a group of players sit together at a table with a deck of cards to play poker. Very often the players bet and the players can win or lose money based on their results. Poker can also be played at a casino or similar places where the players can bet and gain return based on their poker results.

Poker can also be played via the internet. A large variety of sites offer people in different geographic locations to play remotely at the same ‘virtual’ poker table. The internet games can be accessed by a variety of gaming machines, for example a desktop computer, a mobile phone or a mobile computing device. The profit of the administrators of these internet sites depends on the number of players who visit their sites. Hence, there has been a lot of interest in developing online poker games that are both profitable to operate and exciting for the players to take part in.

A problem related to poker play is boredom. One reason for boredom is that there are frequently times at which the player is inactive, such as after folding.

WO07078372 describes a method for computer gaming, comprising: providing a first table of a first group of players grouped together to play a first hand; providing to each of the first group of players one or more cards for the first hand; receiving from a first player of the first group of players a request to fold the one or more cards of the first player; and automatically moving the first player to a second table of a second group of players grouped together to play a second hand. According to this method, the players who folded do not have to wait until the end of the first hand to start a new hand.

While this method alleviates players' boredom by reducing the waiting time, the folding becomes such an attractive option for the players that it may entice the players to fold more frequently.

When too many players fold rather then fighting till the end, the bet tends not to go very high. This makes the game boring for some players. The lower level of betting also leads to less money being spent during the game which is unfavorable to the provider of the game service.

### SUMMARY OF THE INVENTION

It is an object of the present invention to provide a computer gaming device which reduces the above described problems.

Accordingly, the present invention provides a game machine system for a game to be played by n players in which each player is assigned to a position of a different preferability, n being an integer of at least 2, wherein the system comprises a processor configured to:

A) assign a player to a first group of n players grouped together to play a first game,
B) when the player leaves the first game, determine whether the player left the first game by winning or by losing and
C) assign the player to a winner queue if the player left the first game by winning and to a loser queue if the player left the first game by losing,
D) start a second game when the total number of players in the winner queue and the loser queue reaches n, by
D1) assigning one player from the winner queue to the most preferred position and (n−1) players from the loser queue to the remaining positions when the winner queue comprises at least one player and
D2) assigning n players from the loser queue to the most preferred position and the remaining positions when the winner queue comprises no player.

The game to be played with the game machine system according to the present invention consists of a number of rounds. Each player decides whether he folds or not (i.e. call or raise) in each round. The player leaves the game either when he folds or when the game ends, at which point the winner of the game is decided.

The player can win the game by having a higher hand than the other players or by all the other players folding. The player can lose by folding before the end (the ‘showdown’) or by fighting until the end and not having the highest hand. In case there is a split pot, then no player is considered to be a winner.

Herein, the term “to fold” is understood to mean the player does not call or raise but instead discards his cards and leaves the game. The game may continue if there are at least two remaining players.

According to the system of the present invention, the processor determines how the player left a game. Depending on how he left the game, the processor assigns the player to the most preferred position or other positions for the next game.

When the player leaves a game, the player is put in a winner queue if the player left the first game by winning and to a loser queue if the player left the first game by losing. The players for playing the next game are picked from the winner queue and the loser queue.

The next game starts when there are enough players in the winner queue and the loser queue. If the winner queue has at least one player, then one player from the winner queue is assigned to the most preferred position. The (n−1) players from the loser queue are assigned to the non-preferred positions. If the winner queue does not comprise any player, then n players from the loser queue starts the new game. In this case, one of the players in the loser queue is assigned to the preferred position. The player from the loser queue who is assigned to the preferred position may be determined randomly, according to a first in first out basis, or according to other criteria.

The choice of the players from the queues to start the next game may be made randomly, or more preferably, according to a first in first out basis.

According to the present invention, the winner is ensured that he will get the most preferred position in the next game. This gives a further motivation for the player to win a game, which is possible only by not folding. This entices the players to fight until the end, which makes the game more interesting and a higher amount of money spent per game.

The players who were grouped together to play a game are not likely to be assigned to the same table for a new game, especially if there are a large number of games being played at the same time. The new game is likely to be played by the players who played the previous game at different tables. This reduces the possibility of collusion, since it is more difficult for the players attempting collusion to sit at the same table for the next game.

Herein, the “most preferred position” or “highest preferability” is the position in a game that has the most advantageous betting position. In poker, this position is known in poker to be “the button”. This is the most preferred position in the game because the player in this position acts last after all the other players at the table have played their hand, folded or betted.

Similarly, the position with the lowest preferability is the position in a game that has the least advantageous betting position. In poker, this position is known in poker to be “Big Blind.” The player in this position acts first before all the other players.

The position at the poker table that has the second lowest preferability is known in poker to be “Small blind”, The player in this position acts only after the player at “Big Blind” position.

Between the button and the small blind, other positions may be present depending on the number of players in the game. For example, the following terms are used when there are 10 players.

The position at the poker table that has the highest preferability after “Button” is known in poker to be “Cut-off”.

The position at the poker table that has the highest preferability after “Cut-off” is known in poker to be “the Hijack”.

The position at the poker table that has the lowest preferability after “Small blind” (third lowest preferability) is known in poker to be “under the gun”.

The position at the poker table that has the fourth lowest preferability is known in poker to be “under the gun+1”.

The position at the poker table that has the fifth lowest preferability is known in poker to be “under the gun+2”.

The position at the poker table that has the sixth lowest preferability is known in poker to be “under the gun+3”.

The position at the poker table that has the seventh lowest preferability is known in poker to be “under the gun+4”.

The processor is configured to start the second game when there are enough players. This means that if the player folds before the showdown, there is a possibility for him to start the new game without everyone playing the first game having finished the first game. The player can just leave (i.e. become inactive in) the first game and start the second game while the other players continue playing the first game.

For example, if the loser queue comprises (n−1) players when the player folds, the player who folded is assigned to the loser queue, resulting in n players in the loser queue. The next game is then immediately started before the end of the first game. This has the advantage that the waiting time for the player who folded is reduced. The player who folded may still see how the game evolved until it is decided which player has won the game.

The processor may be configured to: perform step B) by:

if the player left the game by losing, giving points to the player according to the number of rounds the player did not fold and
perform step D) by assigning the players from the loser queue to positions according to their points.

According to this embodiment, the positions of the losers for the next game depend on how they played the previous game.

Every time the player does not fold in his turn, he gets a point. The player can lose by folding before the end (the ‘showdown’) or by fighting until the end (the ‘showdown’) and having a lower hand than another player. When he finally folds or loses at the showdown, he is placed in the loser queue with his points. The points matter only when the player loses and is placed in the loser queue. If he wins the game, he is placed in the winner queue, but his points are not considered for the next game.

When the new game is played, the players from the loser queue are assigned to their respective positions according to their points. The player with more point is assigned to a more preferable position.

When there is at least one player in the winner queue (step D1) case), one player from the winner queue is assigned to the most preferred position. The second most preferred position is assigned to the player from the loser queue who has the most point, the third most preferred position is assigned to the player from the loser queue who has the second most point, and so on.

When there is no player in the winner queue (step D2) case), the most preferred position is assigned to the player from the loser queue who has the most point, the second most preferred position is assigned to the player from the loser queue who has the second most point, and so on.

If there are more than one player with the same points, the more preferred position may be taken by the player who has been in the loser queue shorter or longer. Alternatively, the assigning of the players with the same points may be random.

The number of players to play a game, n, is preferably 2 to 10, more preferably 3-5, more preferably 4.

A new player can join the system while the other players are playing. The processor may be configured to assign a new player to the loser queue. The new player may be assigned to the loser queue with 0 point. It is also possible for the processor to give the new player a certain point.

Players may leave the gaming system according to the present invention any time. If a player wants to leave while the game is being played, he has to first fold to leave the game and then leave the gaming system. A player may also leave the gaming system while he is in the queue.

The number of players who are active in the system, i.e. the players playing a game and the players in the queue waiting to play a game, may vary within a large range. The minimum number of players for the system to operate may be set by the system administrator. For example, the system may require m active players to operate, m being an integer at least equal to n. The integer m may e.g. be n, n+1, n+2, n+10, etc. The maximum number of players may also be set by the system administrator. For example, it may be 5n, 10n, 100n etc. Typically, the integer m is at least 10.

If the number of active players in the system becomes less than m during the operation of the system, the system may end the operation and inform the remaining active players accordingly.

Especially when the number of active players in the system is low, there may be a situation in which no new game may be started. For example, if there are less than (n−1) players in the loser queue and there is no game being played, no new game can be started since no more player is going to join the queue. In that situation, the system may end the operation and inform the remaining active players accordingly. Alternatively, if there are many players in the winner queue and less than (n−1) players in the loser queue, the players in the winner queue may be given the option of starting the new game while being informed that they may not get the most preferred position.

The game for the game machine system according to the present invention is typically played online. Online game play is well-known in the art, for example as described in WO07078372, and thus online game play per se is not described herein more than is necessary. WO07078372 is incorporated herein by reference in its entirety.

The processor of the system according to the present invention may be embodied in a server and the players access the server via different access terminals located at different locations. The access terminals which may take the form of a personal computer may provide only the user input device and display device but the processing necessary to play the game is provided remotely via a server, wherein the server is accessed via a communication network.

In a different embodiment, the processor of the system according to the present invention may be embodied e.g. in a personal computer. The personal computer is suitably programmed to perform the gaming method of the present invention. The personal computer allows the user to interact with other players at other personal computers.

Examples of the game for the game machine system according to the present invention include electronic poker games such as Hold ‘Em, Omaha, Omaha Hi-Low, Seven Card Stud and Seven Card Stud Hi-Low.

A further aspect of the present invention provides a method for playing a game on a computer, which game is to be played by n players in which each player is assigned to a position of a different preferability, n being an integer of at least 2, wherein the method comprises the steps of:

A) assign a player to a first group of n players grouped together to play a first game,
B) when the player leaves the first game, determine whether the player left the first game by winning or by losing
C) assign the player to a winner queue if the player ended the first game by winning and to a loser queue if the player ended the first game by losing and
D) start a second game when the total number of players in the winner queue and the loser queue reaches n, by
D1) assigning one player from the winner queue to the most preferred position and (n−1) players from the loser queue to the remaining positions when the winner queue comprises at least one player and
D2) assigning n players from the loser queue to the most preferred position and the remaining positions when the winner queue comprises no player. The player uses an input device to indicate his choice of actions to be processed by the computer.

In the method according to the present invention, preferably, n is an integer of 2 to 10, preferably 3-5, more preferably 4.

In the method according to the present invention, preferably, step B) is performed by:

if the player left the game by losing, giving points to the player according to the number of rounds the player did not fold and
step D) is performed by assigning the players from the loser queue to positions according to their points.

In the method according to the present invention, preferably, when a new player joins the new player is assigned to the loser queue.

In the method according to the present invention, preferably, the new player is given 0 points when the new player is assigned to the loser queue.

In the method according to the present invention, preferably, step D) is performed by choosing the players from the winner queue and the loser queue according to a first in first out basis.

A further aspect of the present invention provides a logic embodied in a computer readable medium, the computer readable medium comprising code operable to perform the method according to the present invention.

### BRIEF DESCRIPTION OF THE DRAWINGS

The invention will be described below referring to embodiments of the invention and drawings in which:

FIG. 1 shows the seating convention used in the following examples;

FIGS. 2A-C show an example of the playing scheme for two games of poker being played simultaneously at two tables;

FIGS. 3A-E show an example of the playing scheme for three games of poker being played simultaneously at three tables;

FIGS. 4A-E show an example of the playing scheme for three games of poker being played simultaneously at three tables where players are ranked according to the outcomes of their playing activities; and

FIG. 5 schematically illustrates an example of the game machine system according to the present invention.

### DETAILED DESCRIPTION OF THE INVENTION

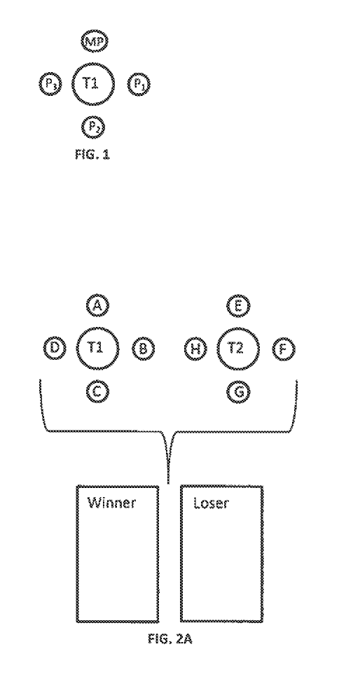

FIG. 1 shows the seating convention used in the following examples, MP stands for most preferred position (button), P1 stands for second highest preferability (cut off), P2 stand for second lowest preferability (small blind) and P3 stands for lowest preferability (big blind).

### EXAMPLE

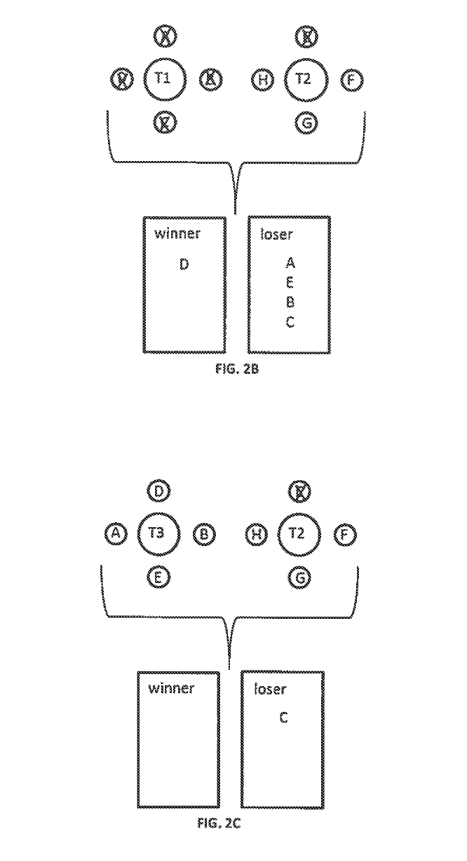

FIGS. 2A-C show an example of how the game develops when two games of poker are played by 8 players simultaneously. In this example, the game is to be played by 4 players. In this example, the processor is configured such that the winner is assigned to the most preferred position, simply referred as the preferred position, and the losers are assigned to other positions at random in the next game.

Referring to FIG. 2A, 8 players are assigned to Table 1 and Table 2. Each table comprises 4 players. At Table 1 are players A, B, C, D and at Table 2 are players E, F, G, H.

The games are started and player A is the first to fold and is therefore placed in the loser queue. Player E from Table 2 is the next to fold and is also placed in the loser queue. Player B is the next to fold and so is placed in the loser queue. Player C then loses to player D. Player D is placed in the winner queue and Player C is placed in the loser queue. At this point the winner queue comprises player D and the loser queue comprises A, E, B and C, as shown in FIG. 2B. There are now total of 5 players in the winner queue and the loser queue, enough to start a new game.

Since there is a player (player D) in the winner queue, player D is to take part in the next game. Players A, E and B have all been waiting in Loser queue for longer than C. A first in first out system is employed for deciding the players for the new game in this example. The next game will hence be composed of player A, E, B and D who are placed in Table 3. The situation is shown in FIG. 2C. In Table 3, Player D receives the most preferred position because Player D won the table. The remaining 3 players, in this example A, E and B receive other positions. A, E and B are seated at random at Table 3 in this example. Player C remains in the loser queue until a sufficient number of players are present in loser queue and winner queue to start the next game.

The games continue in the same manner as described above.

### Example 2

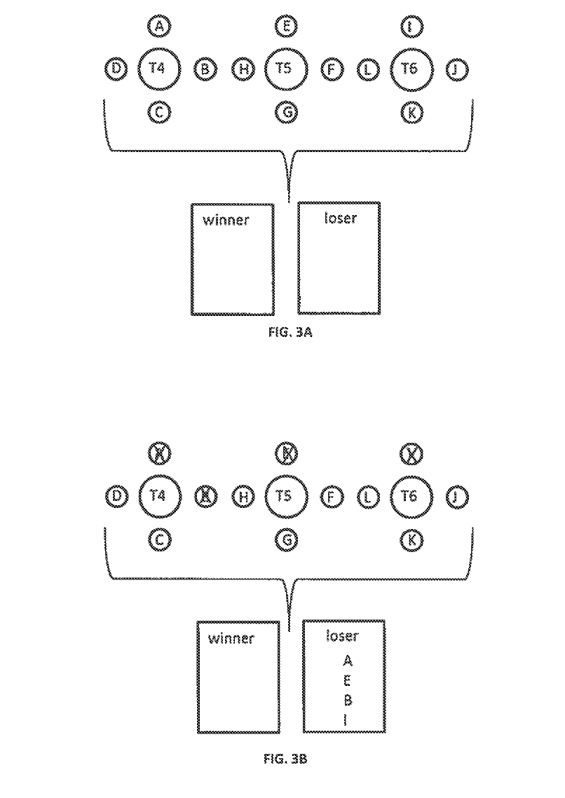

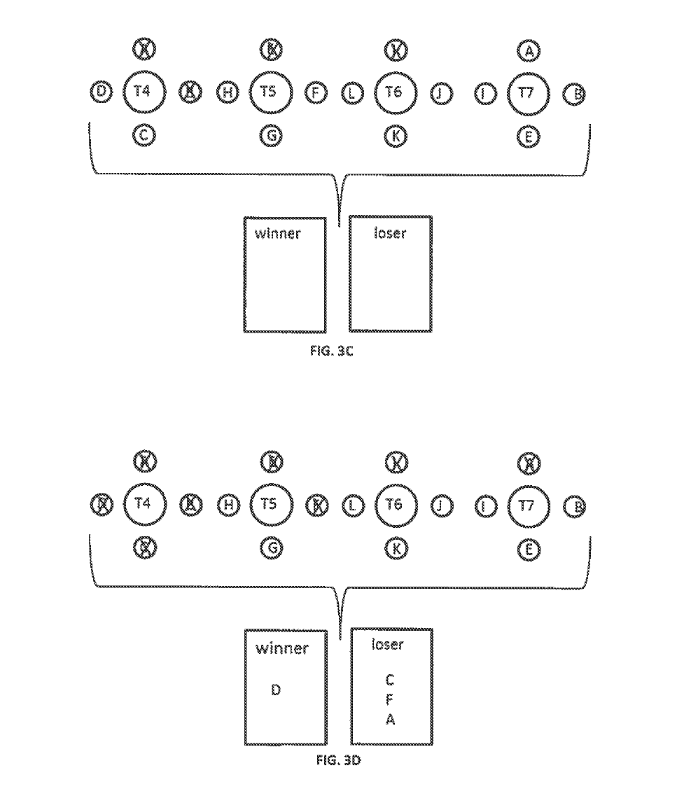

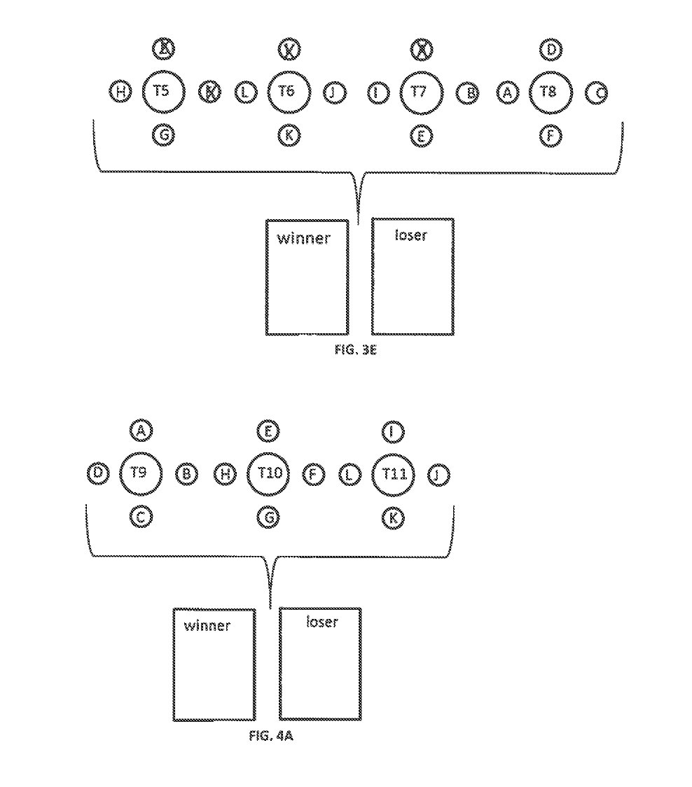

FIGS. 3A-E show an example of how the game develops when three games of poker are played by 12 players simultaneously. In this example, the game is to be played by 4 players. In this example, the winner is assigned to the preferred position and the losers are assigned to other positions at random in the next game.

Referring to FIG. 3A, 12 players are assigned to Table 4, 5 and 6. Each table comprises 4 players. At Table 4 are players A, B, C, D. At Table 5 are players E, F, G, H. At Table 6 are players I, J, K and L.

Player A from Table 4 is the first player to fold and is placed in the loser queue. Player E from Table 5 is the next person to fold and is placed in the loser queue, Player I from Table 6 is the next person to fold and is also placed in the loser queue. The next person to fold is Player B from Table 4. There are now 4 players in the loser queue, as shown in FIG. 3B, and the criterion for the minimum number of players needed to start a new game has been met. Table 7 is therefore started, with the preferred position determined randomly as the players of table 7 are all from the loser queue.

As shown in FIG. 3C, the games at Table 4-6 continue with the remaining players C, D at Table 4, F, G H at Table 5 and J, K, L at Table 6. The game is simultaneously played at Table 7.

Player C loses to Player D and therefore Player C is placed in loser queue and Player D is placed in winner queue. There is at this point in time an insufficient number of players in the loser queue and the winner queue to begin a new poker game and so player C and D must wait.

Player F from Table 4 is the next player to fold and is placed in the loser queue, Player A from table 7 is the next player to fold and is placed in the loser queue. At this point, the situation is as shown in FIG. 3D. The loser queue now has 3 players and the winner queue has 1 player thus the criterion for the minimum number of players for the next table has been met. Table 8 is therefore started, with the preferred position assigned to player D. Players C, F and A receive non-preferred positions distributed as random. This is shown in FIG. 3E.

### Example 3

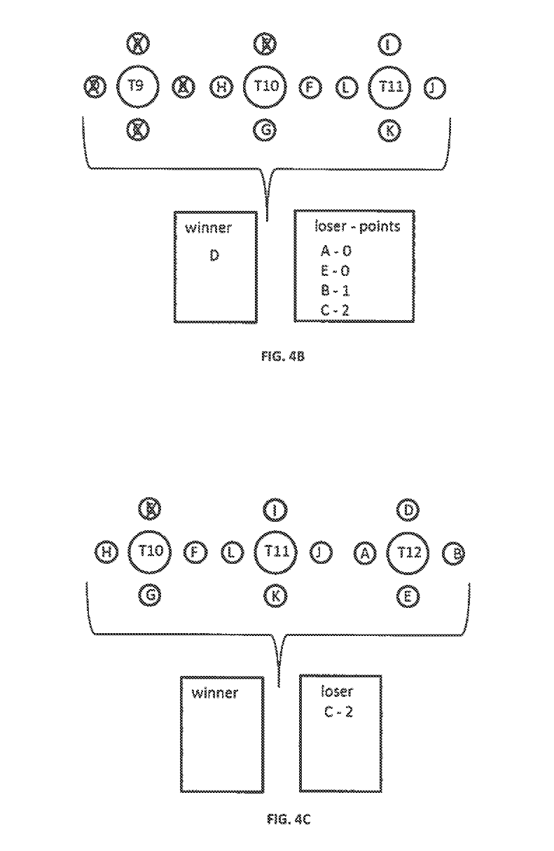

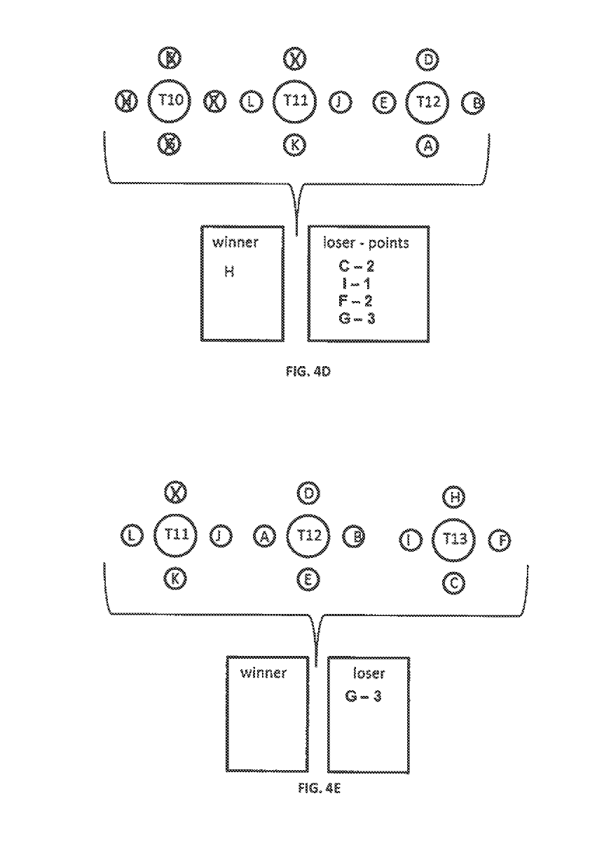

FIGS. 4A-E shows an example of how the game develops when three games of poker are played by 12 players simultaneously. In this example, the game is to be played by 4 players. In this example, the winner is assigned to the most preferred position and the losers are assigned to other positions according to the points according to the number of rounds the player did not fold.

Referring to FIG. 4A, 12 players are assigned to Table 9, 10 and 11. At Table 9 are players A, B, C and D. At Table 10 are players E, F, G and H. At Table 11 are players I, J, K and L.

Player A at Table 9 is the first to fold. He folded in the first round and so does not receive any points. Player A is placed in the loser queue. The second player chronologically to fold is Player E at Table 2. Player E is also placed in the loser queue and also does not receive any points as he also folded in the first round, Player B at Table 10 places one bet prior to folding and therefore receives 1 point, Player B is also placed in the loser queue. At Table 9 Player C loses to player D in the third round. Player C is rewarded for not folding two rounds by receiving 2 points. Player D is rewarded with a place in the winner queue.

The loser queue and the winner queue now contain more than the minimum number of players to form a new table, as shown in FIG. 4B. In this example, the players who have been waiting the longest are placed at the next table and the players in the loser queue are seated according to the number of points they have been awarded. When the players from the loser queue have the same points, the player who has been in the loser queue for a longer time is assigned a position with a lower preferability.

Table 12 is started by player D, A, E and B. Player C remains in the loser queue since player C was the last to join the loser queue. Player D won the hand and is therefore rewarded with the most preferred seat, the Button. Player A and E have D points and Player B has 1 point. Player B has the highest point among the players from the loser queue, so he is rewarded with the second preferred position, the Cut-Off seat. Player A was in the queue longer than player E, so he is placed in the least preferred position, the Big Blind position. Player E receives the Small Blind position. This is shown in FIG. 4C.

The game continues at Table 10, 11 and 12. Player I at Table 11 places one bet before folding and is therefore rewarded with 1 point and placed in the loser queue. Player F at Table 2 folds during the third round and is therefore rewarded with 2 point and placed in the loser queue. Player G loses to Player H in this round. Player is therefore awarded 3 points and is placed in the loser queue. Player H is placed in the winner queue. This is shown in FIG. 4D.

There is now the minimum number of players necessary for the next table to start. Table 13 is started by player H, C, I and F, Player has to wait in the loser queue. Player H won the hand and is therefore rewarded with the most preferred seat, the Button. Player C has 2 points. Player I has 1 point. Player F has 2 points. Players C and F both have 2 points, but player Chas been in the loser queue longer so receives a less preferred position than player F. Accordingly, player F gets the Cut-off seat, player C gets the small blind, player I gets the big blind. This is shown in FIG. 4E.

It is noted that the examples have been described with a relatively small number of players for simplicity's sake. It will be appreciated that the present invention may be carried out with a far larger number of players, such as 50 players. In such a case, there will virtually be no waiting time for the player to play the next game.

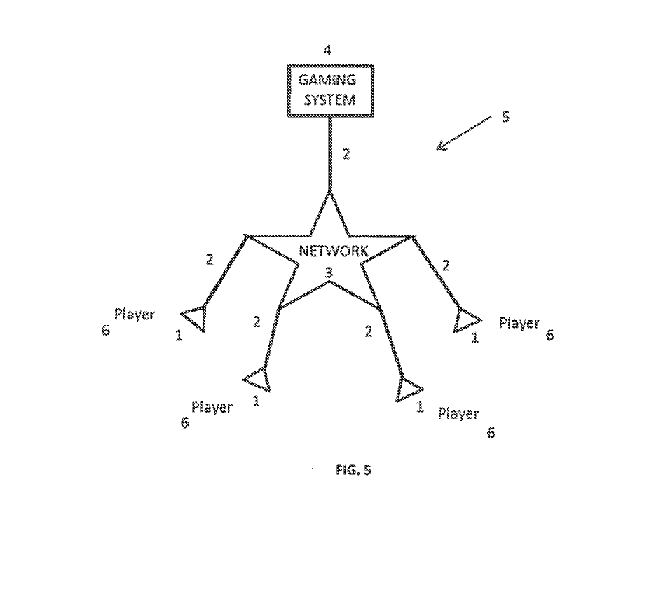

FIG. 5 illustrates an example of a gaming network 5 comprising a game machine system 4 in accordance with a particular embodiment of the present invention and plurality of access means 1. The access means may e.g. be a personal computer. Gaming system 4 comprises a processor for carrying out the method of the present invention. Gaming system 4 is coupled to the access means 1 through a communication network 3. Communication network 3 allows the gaming system 4 to communicate with the plurality of access means 1 via a plurality of communication links, 2. Gaming system 4 provides various games for play by players 6 accessing gaming system 4 through access means 1.

What is claimed is:

1. A game machine system for a game to be played by n players in which each player is assigned to a position of a different preferability, n being an integer of at least 2,
wherein the system comprises: a processor configured to:
A) assign a player to a first group of n players grouped together to play a first game,
B) when the player leaves the first game, determine whether the player left the first game by winning or by losing and
C) assign the player to a winner queue if the player left the first game by winning and to a loser queue if the player left the first game by losing,
D) start a second game when the total number of players in the winner queue and the loser queue reaches n, by
D1) assigning one player from the winner queue to a most preferred position and (n−1) players from the loser queue to the remaining positions when the winner queue comprises at least one player and
D2) assigning n players from the loser queue to the most preferred position and the remaining positions when the winner queue comprises no player.

2. The system according to claim 1, wherein n is an integer of 2 to 10, preferably 3 to 5, more preferably 4.

3. The system according to claim 1, wherein the processor is configured to: perform step B) by:
if the player left the game by losing, giving points to the player according to the number of rounds the player did not fold and
perform step D) by assigning the players from the loser queue to positions according to their points.

4. The system according to claim 1, wherein when a new player joins the system the processor is configured to assign the new player to the loser queue.

5. The system according to claim 4, wherein the processor is configured to give the new player 0 point when assigning the new player to the loser queue.

6. The system according to claim 1, wherein the processor is configured to perform step D) by choosing the players from the winner queue and the loser queue according to a first in first out basis.

7. A method for providing a game to be played on a computer, wherein the game is to be played by n players in which each player is assigned to a position of a different preferability, n being an integer of at least 2, the method comprising the steps of:
A) assigning a player to a first group of n players grouped together to play a first game,
B) when the player leaves the first game, determining whether the player left the first game by winning or by losing and
C) assigning the player to a winner queue if the player left the first game by winning and to a loser queue if the player left the first game by losing,
D) starting a second game when the total number of players in the winner queue and the loser queue reaches n, by
D1) assigning one player from the winner queue to a most preferred position and (n−1) players from the loser queue to the remaining positions when the winner queue comprises at least one player and
D2) assigning n players from the loser queue to the most preferred position and the remaining positions when the winner queue comprises no player.

8. The method according to claim 7, wherein n is an integer of 2 to 10.

9. The method according to claim 7, wherein step B) is performed by:
if the player left the game by losing, giving points to the player according to the number of rounds the player did not fold and
step D) is performed by assigning the players from the loser queue to positions according to their points.

10. The method according to claim 7, wherein when a new player joins the new player is assigned to the loser queue.

11. The method according to claim 10, wherein the new player is given 0 points when the new player is assigned to the loser queue.

12. The method according to claim 7, wherein step D) is performed by choosing the players from the winner queue and the loser queue according to a first in first out basis.

13. Logic embodied in a computer readable medium, the computer readable medium comprising code operable to perform the method according to claim 8.

14. The system according to claim 2, wherein when a new player joins the system the processor is configured to assign the new player to the loser queue.

15. The system according to claim 3, wherein when a new player joins the system the processor is configured to assign the new player to the loser queue.

16. The system according to claim 14, wherein the processor is configured to give the new player 0 point when assigning the new player to the loser queue.

17. The system according to claim 15, wherein the processor is configured to give the new player 0 point when assigning the new player to the loser queue.

18. The method according to claim 8, wherein step B) is performed by:
if the player left the game by losing, giving points to the player according to the number of rounds the player did not fold and
step D) is performed by assigning the players from the loser queue to positions according to their points.

19. The method according to claim 18, wherein when a new player joins the new player is assigned to the loser queue.

20. The method according to claim 10, wherein the new player is given 0 points when the new player is assigned to the loser queue and wherein step D) is performed by choosing the players from the winner queue and the loser queue according to a first in first out basis.
